(19) United States
(12) Patent Application Publication
(10) Pub. No.: US 2009/0103617 A1
(43) Pub. Date: Apr. 23, 2009

(54) EFFICIENT ERROR RECOVERY WITH INTRA-REFRESH

(75) Inventors: Oscar Chi Lim Au, Hong Kong (CN); Mengyao Ma, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 11/876,026

(22) Filed: Oct. 22, 2007

(51) Int. Cl. H04N 7/26

(52) U.S. Cl. 375/240.13; 375/240.27; 375/E07.147

(57) ABSTRACT

Systems and methodologies for concealing errors related to INTRA-frame losses in a transmitted video signal are provided herein. Systems and methodologies provided herein can refine a lost INTRA-coded frame and its subsequent INTER-coded frames using INTRA-coded macroblocks that are provided in a video bitstream in accordance with a Random INTRA Refresh (RIR) scheme. When an INTRA-frame is lost, INTRA-coded macroblocks can be used to refine neighboring INTER-coded macroblocks based on region filling, spatial interpolation, or other algorithms that are based on the strong correlation between values of adjacent pixels in a video signal. Further, motion compensation can be used to refine an INTER-coded pixel having an INTRA-coded pixel in its motion trajectory.

### TECHNICAL FIELD

The present disclosure relates generally to video signal communication, and more particularly to techniques for concealing errors associated with frame loss in a video signal.

### BACKGROUND

Error resilience (ER) and error concealment (EC) techniques for video signals have significantly increased in importance recently due to the use of predictive coding and variable length coding (VLC) in video compression. Of these two types of techniques, error concealment techniques are more widely used for low bit-rate applications as they require no change to an encoder and do not increase the bit rate of a transmitted video signal. Many traditional error concealment techniques assume that only a small number of macroblocks (MBs) or slices in a video frame are lost. However, in low bit-rate applications, data packets typically carry entire frames in order to save transmission overhead. As a result, the loss of a packet in such an application can lead to the loss of an entire frame.

In many currently utilized block-based video coding systems, a video signal is encoded as a series of INTER-frames (“P-frames”) and INTRA-frames (“I-frames”) such that INTER-frames are encoded based on a preceding INTRA-frame. Therefore, it is important to provide protection and restoration for INTRA-frames in order to ensure proper decoding of subsequent INTER-frames. However, most conventional error concealment algorithms that provide recovery from frame loss in a video signal focus only on the restoration of INTER-frames. For example, conventional error concealment methods often restore a lost INTER-frame by copying from previously received frames and/or by recovering motion vectors at a pixel or block level based on an assumption of translational motion. It is typically assumed in conventional error concealment algorithms that provide restoration for INTRA-frames that only part of an INTRA-frame is lost or corrupted, thereby allowing lost MBs in the INTRA-frame to be reconstructed using information from neighboring MBs. However, the loss of a packet in a low bit-rate video transmission usually results in the loss of an entire frame. Accordingly, there exists a need for error concealment techniques that can provide recovery from a loss of an entire INTRA-frame.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure provides systems and methodologies for concealing errors related to INTRA-frame losses in a transmitted video signal. In particular, algorithms are provided herein that can improve the quality of a reconstructed video signal when an INTRA-frame is lost. In accordance with one aspect described herein, the systems and methodologies described herein can be utilized to refine both a lost INTRA-frame and its subsequent INTER-frames. In accordance with another aspect, algorithms provided herein can utilize INTRA-coded MBs (i.e., INTRA-MBs or “I-blocks”) that are provided in a video bitstream coded using a Random INTRA Refresh (RIR) scheme. When an INTRA-frame is lost, received INTRA-MBs in subsequent frames can be used to refine their neighboring INTER-coded MBs (i.e., INTER-MBs or “P-blocks”) based on the strong correlation between values of adjacent pixels in a video signal. In one example, a region-filling algorithm can be used to fill target pixels, and higher synthesis priority can be given to regions along strong edges. Additionally and/or alternatively, motion compensation (MC) can also be used to refine an INTER-coded pixel having an INTRA-coded pixel in its motion trajectory.

To the accomplishment of the foregoing and related ends, certain illustrative aspects of the claimed subject matter are described herein in connection with the following description and the annexed drawings. These aspects are indicative, however, of but a few of the various ways in which the principles of the claimed subject matter can be employed. The claimed subject matter is intended to include all such aspects and their equivalents. Other advantages and novel features of the claimed subject matter can become apparent from the following detailed description when considered in conjunction with the drawings.

### BRIEF DESCRIPTION OF THE DRAWINGS

FIG. 1 is a high-level block diagram of a system for communicating and processing a video signal in accordance with various aspects.

FIG. 2 is a block diagram of a system for concealing an error associated with frame loss in a video signal in accordance with various aspects.

FIG. 3 is a block diagram of a system that facilitates recovery from a frame loss in a video signal in accordance with various aspects.

FIGS. 4A-4B illustrate performance data for an exemplary error concealment system in accordance with various aspects.

FIG. 5 illustrates image quality data for an exemplary error concealment system in accordance with various aspects.

FIGS. 6A-6B illustrate performance data for an exemplary error concealment system in accordance with various aspects.

FIG. 7 is a flowchart of a method of processing a video signal in accordance with various aspects.

FIG. 8A is a flowchart of a method of concealing an error in a video signal in accordance with various aspects.

FIG. 8B is a flowchart of a method of concealing an error in a pixel using motion compensation.

FIG. 8C is a flowchart of a method of concealing an error in a macroblock using region filling.

FIG. 9A is a flowchart of a method of concealing an error in a video signal in accordance with various aspects.

FIG. 9B is a flowchart of a method of concealing an error in a pixel using motion compensation.

FIG. 9C is a flowchart of a method of concealing an error in a pixel using spatial interpolation.

FIG. 10 is a block diagram of an example operating environment in which various aspects described herein can function.

FIG. 11 is a block diagram of an example networked computing environment in which various aspects described herein can function.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, the methods and apparatus of the claimed subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the claimed subject matter. The components may communicate via local and/or remote processes such as in accordance with a signal having one or more data packets (e.g., data from one component interacting with another component in a local system, distributed system, and/or across a network such as the Internet with other systems via the signal).

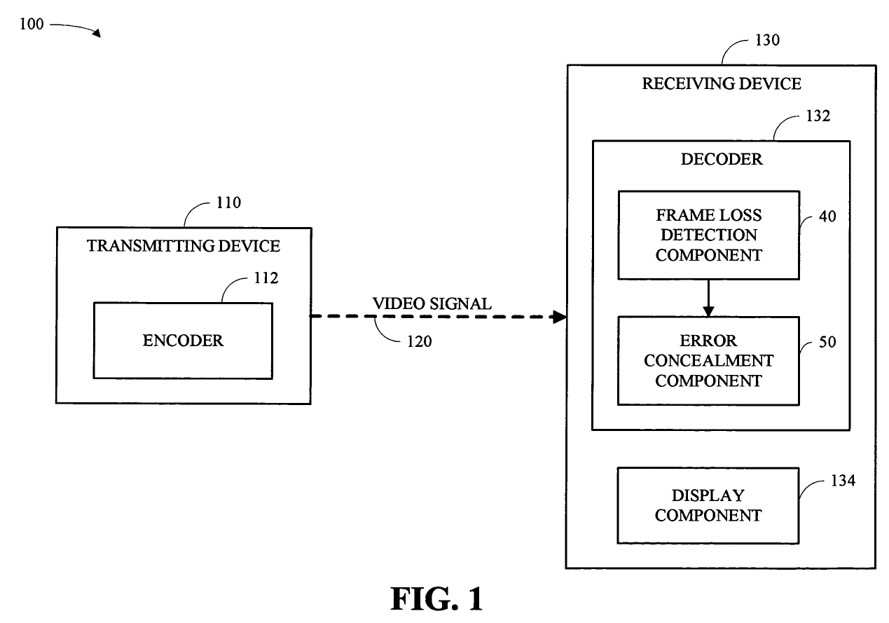

Referring to FIG. 1, a high-level block diagram of a system 100 for communicating and processing a video signal 120 in accordance with various aspects set forth herein is illustrated. In one example, system 100 includes a transmitting device 110 that can transmit one or more video signals 120 to a receiving device 130 that is communicatively connected to the transmitting device 110. By way of non-limiting example, transmitting device 110 and receiving device 130 can communicate over one or more communication channels via a wired (e.g., Ethernet, IEEE-802.3, etc.) or wireless (IEEE-802.11, Bluetooth™, etc.) networking technology. Additionally, transmitting device 110 and receiving device 130 can be directly connected to one another or indirectly connected through a third party device (not shown). For example, transmitting device 110 can be a web server and the receiving device 130 can be a client computer that accesses transmitting device 110 over the Internet via an Internet service provider (ISP). As another example, receiving device 130 can be a mobile terminal that accesses a video signal 120 from transmitting device 110 via a cellular communications network such as the Global System for Mobile Communications (GSM), a Code Division Multiple Access (CDMA) network, and/or another suitable cellular communications network.

In accordance with one aspect, the transmitting device 110 can include an encoder 112, which can prepare one or more video signals 120 for transmission to the receiving device 130. In one example, the encoder 112 can create video signals 120 by encoding raw video data using a codec such as H.263, H.264, MPEG-4, and/or another appropriate codec. Additionally and/or alternatively, the encoder 112 can employ INTER-prediction in connection with one or more codecs to encode raw video data. For example, one or more frames and/or macroblocks (MB) within video frames can be configured to be INTER-coded or INTRA-coded. In one example, INTRA-coded video information in a video signal can be encoded using a discrete cosine transform (DCT) operation and/or another suitable image processing operation independently of other information in the video signal. On the other hand, INTER-coded information can be encoded based on preceding INTRA-coded information. For example, INTER-coded video information can be encoded as a function of one or more motion vectors obtained from the video signal and preceding INTRA-coded information. As a result, while INTER-coded information depends on previously received INTRA-coded information to display correctly, INTER-coded information is generally smaller in size than similar INTRA-coded information.

In another example, the encoder 112 can utilize one or more error resilience (ER) techniques to control errors in a transmitted video signal 120. For example, the encoder 112 can introduce redundancy to a video signal 120 to allow a decoder 132 to use the redundant information to reconstruct a video signal 120 in the case of a transmission error. Additionally and/or alternatively, the encoder 112 can utilize Multiple Description Coding (MDC), wherein a video signal 120 is divided into multiple bit streams or “descriptions,” each of which can be independently transmitted and decoded.

In accordance with another aspect, the receiving device 130 can include a decoder 132 that can receive and process video signals 120 from the transmitting device 110. In one example, the decoder can receive information from a video signal 120 regarding a codec utilized by the encoder 112 at the transmitting device 110 in encoding the video signal 120 and decode the video signal 120 based on this information. Additionally and/or alternatively, the decoder 132 can communicate a video signal 120 to a display component 134 for display and/or further processing.

In accordance with an additional aspect, a connection between the transmitting device 110 and the receiving device 130 can be lossy due to limited bandwidth, channel fading, and/or other factors. As a result, transmission errors may be present in a video signal 120 at the time it reaches the receiving device 130. These transmission errors can include, for example, packet loss and bit corruption. As a result of these transmission errors, data within video signal 120 can become lost or damaged. For example, if the encoder 112 employs INTER-prediction to encode a video signal 120, INTER-coded frames (i.e., INTER-frames, predictive frames, or P-frames) and/or INTER-coded macroblocks (MBs) within frames can be predicted at a decoder 132 from a previously decoded frame by using Motion Compensation. However, if data loss occurs during transmission of the video signal 120, frames corresponding to the lost data can be corrupted or missing. As a consequence of INTER-prediction, errors in the corrupted or missing frames can then propagate to subsequent frames until the next INTRA-coded frame (i.e., INTRA-frame or I-frame) is correctly received. As another example, a simple bit error in a video signal 120 encoded using Variable Length Coding (VLC) can cause desynchronization in a video signal 120, which can render following bits in the video signal 120 unusable until a synchronization code arrives at the decoder 132.

Accordingly, the decoder 132 at the receiving device 130 can include an error concealment component 50, which can conceal one or more transmission errors in a video signal 120 to reduce the appearance of defects in video signal 120 due to such errors. In one example, because the loss of a packet in a low bit-rate video transmission often results in the loss of an entire frame, the error concealment component 50 can be operable to conceal defects in a video signal 120 caused by frame loss. To aid the error concealment component 50 in recovering from a frame loss in a video signal 120, the decoder can further include a frame loss detection component 40 that can detect when a frame in a video signal 120 has been lost. Upon detecting a lost frame in the video signal 120, the frame loss detection component 40 can trigger the error concealment component 50 to recover from the frame loss.

By way of specific example, the error concealment component 50 can conceal errors present in a video signal 120 encoded using INTER-prediction due to a lost frame as follows. In the event of a lost INTER-frame, the error concealment component 50 can conceal the lost INTER-frame by copying an immediately preceding frame to the location of the lost INTER-frame and/or by other suitable methods. In the event of a lost INTRA-frame, the error concealment component 50 can leverage features of a Random INTRA Refresh (RIR) scheme utilized by the encoder 112 in encoding the video signal 120. For example, RIR can be utilized by the encoder 112 to randomly insert INTRA-coded MBs into a video signal 120 to remove artifacts caused by transmission error, INTER-prediction drift, and/or other factors. Because video signals 120 encoded using RIR with a low INTRA-rate are generally smaller in size than similar video signals 120 with periodic INTRA-frames inserted therein, RIR is often utilized by decoders in video transmission systems for low bit-rate applications. Accordingly, the error concealment component 50 can assume that a received video bitstream contains such INTRA-MBs. When an INTRA-frame is lost, received INTRA-MBs in subsequent frames can be used by the error concealment component 50 to refine neighboring INTER-coded MBs using region filling, spatial interpolation, and/or other techniques that are based on the strong correlation between adjacent pixel values and/or other factors. In addition, the error concealment component 50 can further refine an INTER-coded pixel using one or more motion compensation (MC) algorithms if an INTRA-coded pixel exists in its motion trajectory. By propagating INTRA-coded information obtained from RIR performed at the encoder 112 in this manner, the error concealment component 50 can enable faster recovery of a video signal 120 from an INTRA-frame loss than can be achieved with conventional error concealment techniques.

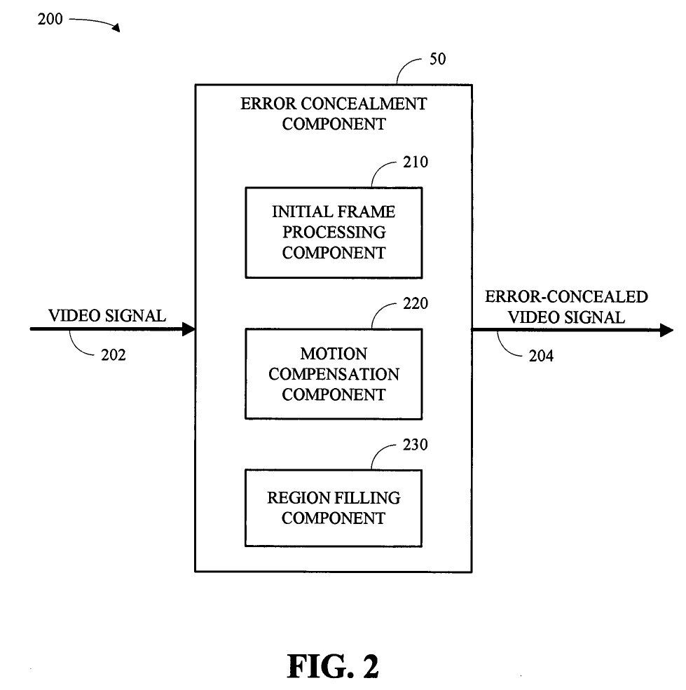

Referring now to FIG. 2, a system 200 for concealing an error associated with frame loss in a video signal 202 in accordance with various aspects is illustrated. In accordance with one aspect, system 200 includes an error concealment component 50 that can conceal errors in a video signal 202 associated with the loss of one or more frames in the video signal 202. The error concealment component 50 can initiate error concealment upon receiving an external notification (e.g., from a frame loss detection component 40) that a frame in a video signal 202 has been lost, or alternatively the error concealment component 50 can itself detect a frame loss and act accordingly. In one example, error concealment component 50 includes an initial frame processing component 210, a motion compensation component 220, and a region filling component 230 that can operate individually or in tandem to perform one or more error concealment algorithms on a video signal 202 to create an error-concealed video signal 204.

In accordance with one aspect, if an INTER-frame is lost in the video signal 202, the error concealment component 50 can reconstruct the lost frame by copying a previous frame to the location of the lost INTER-frame. For example, the error concealment component 50 can perform a copy-previous operation at the location of the missing INTER-frame to copy an immediately preceding frame to the location of the lost frame. In accordance with another aspect, the error concealment component 50 in system 200 can recover from a lost INTRA-frame in a video signal 202 as described in the following non-limiting example.

In conventional error concealment algorithms, only corrupted and/or lost frames are error-concealed. Although subsequent frames can then be decoded as usual, unsightly artifacts in subsequent frames will remain due to drifting errors. In the case of a lost INTRA-frame, artifacts and video quality degradation in subsequent frames is especially troublesome due to INTER-prediction. Accordingly, system 200 can utilize multiple techniques for reconstructing subsequent INTER-coded MBs after a lost INTRA-frame in a video signal. These methods include decoding subsequent INTER-MBs directly, performing error concealment by motion compensation via motion compensation component 220, performing error concealment by region filling via region filling component 230, and/or other suitable techniques.

In one example, when an INTRA-frame I₀ in a video signal 202 is lost, each pixel in the missing INTRA-frame can be filled by the initial frame processing component 210 with a gray color (e.g., 128 for each YUV component). Each of the subsequent N INTER-coded frames, where N is an integer to control the number of frames used for error concealment, can then be decoded by the initial frame processing component 210 and/or another entity internal or external to the error concealment component 50. Once the frames are decoded, they can be error-concealed as follows. First, as the INTRA-MBs coded into the subsequent INTER-frames by RIR can be utilized to stop error propagation, each pixel in each subsequent INTER-frame can be mapped by the initial frame processing component 210 to a mark used to represent whether the corresponding pixel is error-free (refreshed) or not. For example, each pixel in a lost frame can be set to be non-refreshed. If an INTRA-MB is then later received, pixels in each INTER-frame corresponding to the INTRA-MB can be changed to refreshed. It should be appreciated that mapping can be performed for each frame prior to further error concealment processing, or alternatively that mapping can be performed in parallel with other error concealment operations.

When a first INTER-frame P₁ subsequent to a lost INTRA-frame is received and decoded, the initial frame processing component 210 can initialize error concealment by computing the DC coefficient of the INTRA-MBs within the frame to obtain a value denoted as DCᵢₙₜᵣₐ. The initial frame processing component 210 can then fill the reference frame of P₁ (e.g., the buffer for I₀) and non-refreshed pixels of P₁ using DCᵢₙₜᵣₐ. After performing this initialization, each INTER-frame to be error-concealed can be processed by system 200 as follows.

First, the initial frame processing component 210 can divide each frame into its constituent macroblocks. For each such macroblock, the initial frame processing component 210 can then determine whether the macroblock is an INTRA-MB or an INTER-MB. If it is determined that a macroblock is an INTER-MB, motion compensation can be performed on the macroblock by the motion compensation component 220.

In accordance with one aspect, a given INTER-MB MB_{c} can be refined by the motion compensation component 220 pixel by pixel as follows. The motion compensation component can maintain a reference frame buffer of L frames, such that for each pixel p in MB_{c}, a motion vector MV₀ and corresponding reference frame index k₀, k₀ε{1, 2, . . . , L} can be determined. Based on this information, p can then be refined by motion compensation if there is a refreshed pixel in its motion trajectory. By way of specific example, this can be accomplished by the motion compensation component 220 as follows. First, the motion compensation component 220 can initialize a frame index k to 0 and use MV₀ to find the reference pixel of p, herein denoted as q₀. If q₀ lies at an integer-pixel position marked as refreshed, or if q₀ lies at a sub-pixel position surrounded by refreshed pixels, the motion compensation component 220 can mark p as refreshed and stop. Otherwise, the motion compensation component 220 can increment k and determine whether k is greater than L. If k is greater than L, this can indicate that all of the reference frames have been checked, and the motion compensation component 220 can accordingly stop. Otherwise, for each value of k such that k≠k₀, a motion vector of p based on the k-th reference frame can be estimated based on the constant velocity model, e.g., MVₖ=MV₀×k/k₀. The estimated motion vector MVₖ can then be used to find the corresponding pixel qₖ in the k-th reference frame. If qₖ lies at an integer-pixel position marked as refreshed, or if qₖ lies at a sub-pixel position surrounded by refreshed pixels, the motion compensation component 220 can replace p by the pixel value of qₖ, mark p as refreshed, and stop. Otherwise, the motion compensation component 220 can again increment k and repeat the estimation for the next reference frame in the event that k≦L.

In one example, after the motion compensation component 220 performs motion compensation for a macroblock MB_{c}, the error concealment component 50 can check the status of each pixel in MB_{c}. If it is determined that each pixel in MB_{c} is marked as refreshed, the error concealment component 50 can regard MB_{c} as reconstructed and proceed to a new macroblock. Otherwise, the error concealment component 50 can further check whether MB_{c} has at least one fully refreshed neighboring macroblock. Specifically, four neighbors can be checked—MBᵤ, MB_{b}, MBₗ and MBᵣ—which respectively correspond to the upper, bottom, left, and right neighboring macroblocks to MB_{c}. If one or more of the neighboring macroblocks are determined to be fully refreshed, the region filling component 230 can then perform region filling on MB_{c} from the corresponding directions.

By way of example, region filling may be performed on a macroblock having only a fully refreshed upper neighbor MBᵤ by the region filling component 230 as follows. As MBᵤ has been fully refreshed, the current macroblock MB_{c} can be filled from top to bottom by the region filling component 230 using pixel values extracted from MBᵤ to obtain a resulting macroblock MB_{c}^{u}. In one example, region filling can begin by marking all of the pixels of MB_{c}^{u} as unfilled and initializing a row index of MB_{c}^{u} as −1. The region filling component 230 can then increase the row index by 1 and determine whether the row index exceeds 15. If the row index exceeds 15, this can indicate that all of the pixels in MB_{c}^{u} have been filled, and the region filling component 230 can accordingly stop. If the row index does not exceed 15, the region filling component 230 can then further determine whether all of the pixels in the current row have been filled. If each pixel in the current row has been filled, the region filling component 230 can again increment the row index and repeat the above determinations for the following row. Otherwise, the region filling component 230 can compute a horizontal gradient Gₓ for each unfilled pixel in the current row. In one example, the gradients are estimated by applying a Sobel filter on surrounding filled pixels.

Upon finding a pixel with a maximal Gₓ in the current row, herein denoted as \hat{p}, the region filling component 230 can define a patch ψ_{\hat{p}} to be an S×S window centered at pixel \hat{p}. The region filling component 230 can then search in MBᵤ for a patch that is most similar to ψ_{\hat{p}} based on the following equation:

$${ψ}_{\hat{q}} = arg {min}_{{ψ}_{q} ∈ {MB}_{u}} d ( {ψ}_{\hat{p}} , {ψ}_{q} ) , \qquad ( 1 )$$

where the distance between the two patches, d(ψ_{\hat{p}}, ψ_{q}), is defined as the sum of square difference (SSD) of the previously-filled pixels in the two patches. In one example, Luma-components of the pixel values can be used in the calculation. Upon determining a patch ψ_{\hat{q}} in MBA that is most similar to A, the region filling component 210 can copy the corresponding pixel values from ψ\hat{q} into the unfilled region of ψ\hat{p} and repeat the above operations for other unfilled pixels in the current row and/or any subsequent rows.

In accordance with one aspect, the region filling component 230 can reconstruct a macroblock by region filling from multiple directions in a similar manner. For example, the region filling component 230 can extrapolate a neighboring macroblock MBᵢ to obtain a resulting macroblock MB_{c}ⁱ, where MB_{c}ⁱ (x, y) denotes a pixel value of MB_{c}ⁱ at position (x, y), iε{u, b, l, r} and x, yε[0, 15]. Based on the above, the region filling component 230 can then generate an error-concealed macroblock MB_{c}^{rf} as a weighted summation of the four neighboring macroblocks as follows:

$${MB}_{c}^{rf} ( x , y ) = \frac{{\sum }_{i ∈ \{ u , b , l , r \}} {w}_{i} ( x , y ) \times {MB}_{c}^{i} ( x , y )}{{\sum }_{i ∈ \{ u , b , l , r \}} {w}_{i} ( x , y )} , \qquad ( 2 )$$

where wₗ (x, y) is a weighting factor. If Dₗ(x, y) is defined to be the distance from position (x,y) to the nearest boundary of MBᵢ, iε{u, b, l, r}, the weighting factors can then be calculated as follows:

$${w}_{i} ( x , y ) = \{ \begin{matrix} \frac{1}{{‖ {D}_{i} ( x , y ) ‖}^{2}} , & if {MB}_{i} is fully refreshed , \\ 0 , & otherwise .\end{matrix} \qquad ( 3 )$$

In accordance with another aspect, based on the results obtained from the motion compensation component 220 and the region filling component 230, the error concealment component 50 can generate an error-concealed video signal 204. For example, for each pixel in a macroblock MB_{c}^{mc} processed by the motion compensation component 220, the error concealment component 50 can generate a final reconstructed value after region filling by the region filling component 230 as follows:

MB_{c}(x,y)=w_{rf}×MB_{c}^{rf}(x,y)+(1−w_{rf})×MB_{c}^{mc}(x,y), (4)

where a weight w_{rf} is used to control the strength of the region-filling effect.

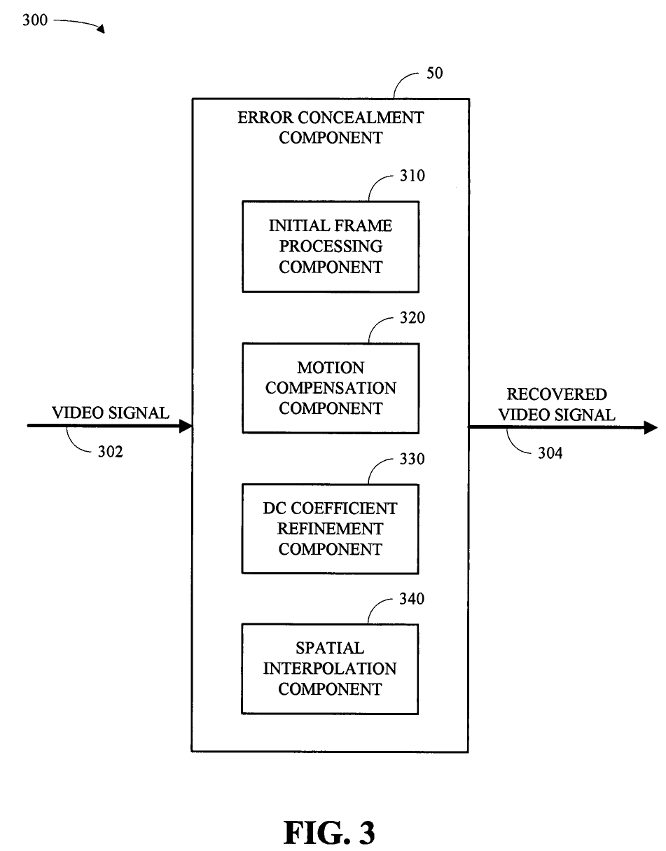

Turning to FIG. 3, a block diagram of a system 300 that facilitates recovery from a frame loss in a video signal 302 in accordance with various aspects is provided. In accordance with one aspect, system 300 includes an error concealment component 50 that can conceal errors in a video signal 302 associated with the loss of one or more frames in the video signal 302. In a similar manner to the error concealment component 50 in system 200, the error concealment component 50 in system 300 can initiate error concealment upon receiving an external notification (e.g., from a frame loss detection component 40) that a frame in a video signal 302 has been lost, or alternatively the error concealment component 50 can itself detect a frame loss and act accordingly. In one example, error concealment component 50 includes an initial frame processing component 310, a motion compensation component 320, a DC coefficient refinement component 330, and a spatial interpolation component 340 that can operate individually or in tandem to perform one or more error concealment algorithms on a video signal 302 to create a recovered video signal 304.

In accordance with one aspect, if an INTER-frame is lost in the video signal 302, the error concealment component 50 can reconstruct the lost frame by copying a previous frame to the location of the lost INTER-frame in a similar manner to the error concealment component 50 in system 200. Further, the error concealment component 50 in system 300 can recover from a lost INTRA-frame in a video signal 302 by error-concealing the lost INTRA-frame and its subsequent INTRA-frames as described in the following discussion. For example, system 300 can utilize multiple techniques for reconstructing subsequent INTER-coded MBs after a lost INTRA-frame in a video signal 302. These methods include decoding subsequent INTER-MBs directly, performing error concealment by motion compensation via motion compensation component 320, performing error concealment based on the DC coefficient of one or more INTRA-MBs via DC coefficient refinement component 330, performing error concealing by spatial interpolation via spatial interpolation component 340, and/or other suitable techniques.

In one example, when an INTRA-frame I₀ in a video signal 302 is lost, each pixel in the missing INTRA-frame can be filled by the initial frame processing component 310 with a gray color (e.g., 128 for each YUV component). Each of the subsequent N INTER-frames, where N is an integer to control the number of frames used for error concealment, can then be decoded by the initial frame processing component 310 and/or another entity internal or external to the error concealment component 50. Once the frames are decoded, they can be error-concealed pixel by pixel as follows. First, as the INTRA-MBs coded into the subsequent INTER-frames by RIR can be utilized to stop error propagation, each pixel in each subsequent INTER-frame can be mapped by the initial frame processing component 310 to a mark used to represent whether the corresponding pixel is error-free (refreshed) or not. In accordance with one aspect, the initial frame processing component 310 can maintain two sets of maps, including a set of frame maps M_{f} corresponding to the pixels of each frame to be error-concealed and a set of smaller maps Mₛ (e.g., of size 16×16) corresponding to the pixels in each INTER-MB within the frames to be error-concealed. Accordingly, each pixel in a lost frame can be given a status of non_filled_mc. If a pixel is later refined by motion compensation, the status of the pixel in Mₛ can then be changed to filled_mc. In addition, values corresponding to respective pixels in frame maps M_{f} can indicate whether a pixel has been refreshed in a similar manner to system 200. It should be appreciated that mapping can be performed for each frame prior to further error concealment processing, or alternatively that mapping can be performed in parallel with other error concealment operations.

When a first INTER-frame P₁ subsequent to a lost INTRA-frame is received and decoded, the initial frame processing component 310 can initialize error concealment by computing the DC coefficient of the INTRA-MBs within the frame to obtain a value denoted as DCᵢₙₜᵣₐ. The initial frame processing component 310 can then fill the reference frame of P₁ (e.g., the buffer for I₀) and each INTER-coded pixel in P₁ using DCᵢₙₜᵣₐ. Additionally and/or alternatively, the initial frame processing component 310 can use the DC coefficient of respective INTRA-MBs in P₁ to fill each INTER-MB that borders the respective INTRA-MBs. After performing this initialization, each INTER-frame to be error-concealed can be processed by system 300 as follows.

First, for each pixel in the frames of the video signal 302 to be error-concealed, the initial frame processing component 310 can then determine whether the pixel is located within an INTRA-MB or an INTER-MB. If the pixel is determined to be in an INTRA-MB, the initial frame processing component 310 can mark the pixel refreshed and begin error concealment of a new pixel. If the pixel is instead determined to be within an INTER-MB, motion compensation can be performed on the pixel by the motion compensation component 320.

In accordance with one aspect, a given pixel p can be refined by the motion compensation component 320 as follows. The motion compensation component 320 can maintain a reference frame buffer of L frames such that a motion vector MV₀ and corresponding reference frame index k₀, k₀ε{1, 2, . . . , L} can be determined for pixel p. Based on this information, p can then be refined by motion compensation if there is a refreshed pixel in its motion trajectory. By way of specific example, this can be accomplished by the motion compensation component 320 as follows. First, the motion compensation component 320 can mark the status of pixel p in Mₛ as non_filled_mc, initialize a frame index k to 0, and use MV₀ to find the reference pixel of p, herein denoted as q₀. If q₀ lies at an integer-pixel position marked as refreshed, or if q₀ lies at a sub-pixel position surrounded by refreshed pixels, the motion compensation component 320 can mark p as refreshed in M_{f} and stop. Otherwise, the motion compensation component 320 can increment k and determine whether k is greater than L. If k is greater than L, this can indicate that all of the reference frames have been checked, and the motion compensation component 320 can accordingly stop. Otherwise, for each value of k such that k≠k₀, a motion vector of p based on the k-th reference frame can be estimated based on the constant velocity model, e.g., MVₖ=MV₀×k/k₀. The estimated motion vector MVₖ can then be used to find the corresponding pixel qₖ in the k-th reference frame. If qₖ lies at an integer-pixel position marked as refreshed, or if qₖ lies at a sub-pixel position surrounded by refreshed pixels, the motion compensation component 320 can replace p by the pixel value of qₖ, mark p as filled_mc in Mₛ, and stop. Otherwise, the motion compensation component 320 can again increment k and repeat the estimation for the next reference frame in the event that k≧L.

In one example, if the motion compensation component 320 sets the status of a pixel p to refreshed or filled_mc, error concealment can conclude for p and the error concealment component can process a new pixel. Otherwise, p can be provided to the DC coefficient refinement component 330 for further processing. In one example, the DC coefficient refinement component 330 can divide a lost video frame containing pixel p into blocks of size D×D, where Dε{4, 8, 16} and pixel p lies in block B_{c}. The DC coefficient refinement component 330 can then check the eight neighboring blocks of B_{c} to determine whether one neighbor lies in an INTRA-MB. If so, the DC coefficient refinement component 330 can refine p by the DC coefficient of the neighboring block, denoted herein as DC_{ub}. In one example, the DC coefficient refinement component 330 can refine p by modifying the value of p to a weighted average of the original value of p and the DC coefficient of the neighboring block as follows:

p=w_{dc}×DC_{nb}+(1−w_{dc})×p, (5)

where w_{dc} is a weighting factor used to control the extent of refinement.

In another example, a pixel p refined by the motion compensation component 320 and/or the DC coefficient refinement component 330 can then be provided to the spatial interpolation component 340 for additional processing as follows. First, the spatial interpolation component 340 can search within a window of size (2S+1)×(2S+1) centered at pixel p for two nearest refreshed pixels to p. If two refreshed pixels are not found in the window, processing of p can conclude and the error concealment component 50 can proceed to a new pixel. Otherwise, for two pixels found during the search, denoted as P₁ and P₂ and having respective distances d₁ and d₂ from p, the spatial interpolation component 340 can compute an interpolated value for p as follows:

$$\hat{p} = \frac{{p}_{1} \times {d}_{2} + {p}_{2} \times {d}_{1}}{{d}_{1} + {d}_{2}} . \qquad ( 6 )$$

Based on Equation (6), and using a weight wₛᵢ to control the strength of spatial interpolation, the spatial interpolation component 340 can then obtain a final value of p as follows:

p=wₛₗ×\hat{p}+(1−wₛₗ)×p. (7)

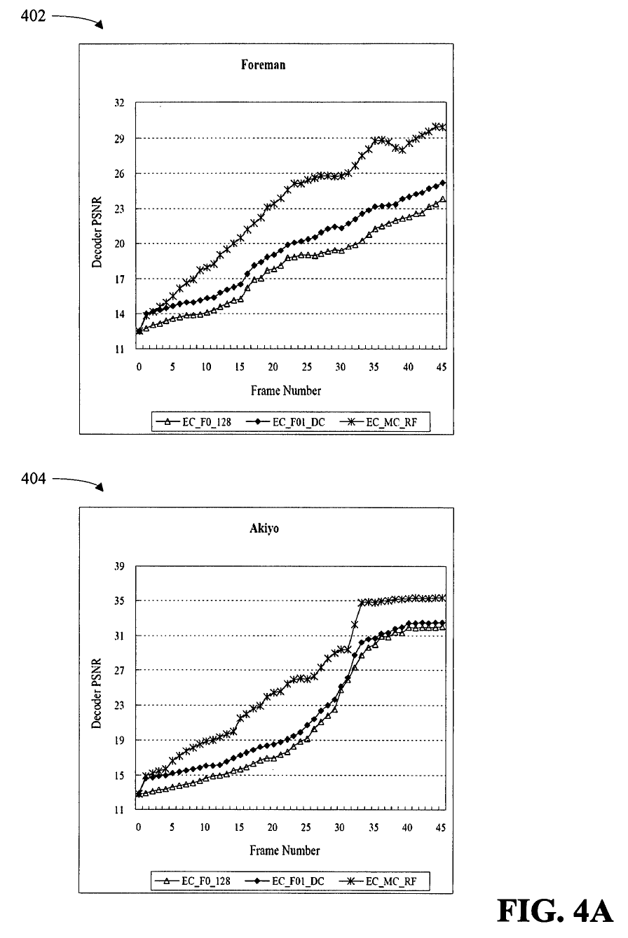

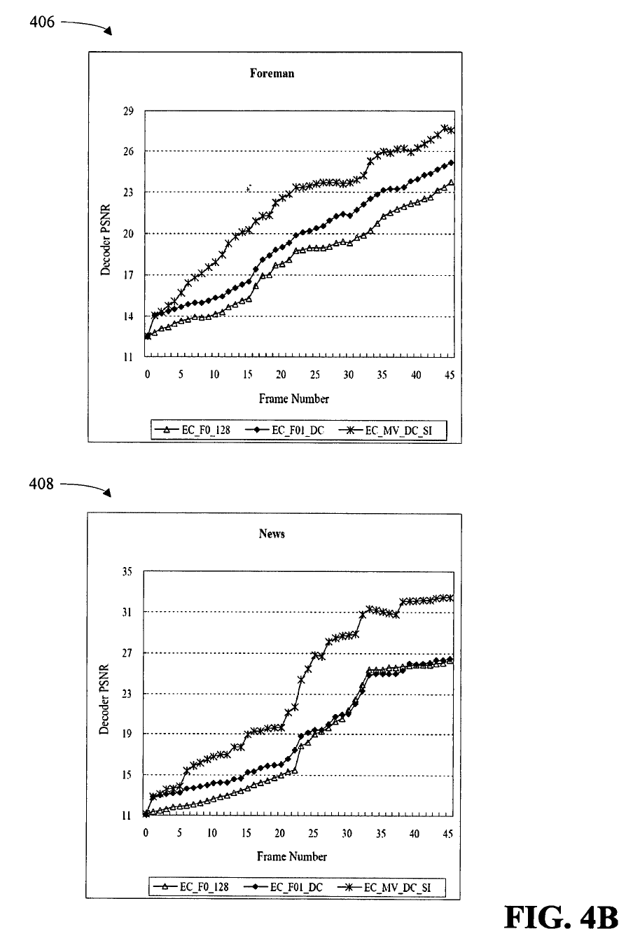

Referring now to FIGS. 4-6, performance and image quality data obtained from an evaluation of example error concealment algorithms that can be employed in accordance with various aspects set forth herein (e.g., by an error concealment component 50) are illustrated. The evaluation was performed using version 11.0 of the JVT reference software according to a baseline profile. The first 300 of the Foreman, News, and Akiyo QCIF test sequences were used in the evaluations. Each test sequence was encoded at 7.5 frames per second with only the first frame as an 1-frame. Two reference frames were used for INTER-prediction during encoding, and INTER-coded pixels were not used for prediction of INTRA-MBs. Further, RIR was utilized with an INTRA-MB rate of 3%, and a constant quantization parameter (QP) of 30 was utilized to encode each test sequence. Further, a simulated transmission was performed for the compressed video sequences such that one packet contains the information of one frame and, consequently, the loss of one packet causes loss of an entire frame. Simulated packet loss patterns were used with loss rates P=3%, 5%, 10%, and 20%. Decoder peak signal-to-noise ratio (PSNR), which was computed using the original uncompressed Foreman, News, and Akiyo sequences as a reference, was used as an objective measurement to measure performance of the evaluated error concealment algorithms. Given a packet loss rate P, each test sequence was transmitted 40 times, and the average PSNR for the 40 transmissions was calculated at the decoder side.

As illustrated by FIGS. 4-6, the evaluated performance of four error concealment algorithms are provided. In the first such algorithm, denoted herein as EC_F0_{—}128, a lost INTRA-frame is filled by a grey color by, for example, setting all of the YUV components of the frame to a value of 128. Frames subsequent to the lost INTRA-frame are then decoded directly. In the second algorithm, denoted herein as EC_F01_DC, a lost INTRA-frame and a first subsequent INTER-frame are error concealed using motion compensation (e.g., performed by a motion compensation component 320) and DC refinement (e.g., performed by DC coefficient refinement component 330), but neither region filling nor spatial interpolation are performed. In the third algorithm, denoted herein as EC_MC_RF, error concealment for a lost INTRA-frame and N subsequent INTER-frames is performed as described supra with regard to system 200, with parameters S=5, w_{rf}=0.5 and N=30. In the fourth algorithm, denoted herein as EC_MV_DC_SI, error concealment for a lost INTRA-frame and N subsequent INTER-frames is performed as described supra with regard to system 300, with parameters w_{dc}=½, wₛₗ=⅓ and S=16. For frames I₀, P₁, P₂, P₃, P₄, . . . , the parameter D=16 is used for P₁ and P₂, and the parameter D=4 is used for P₁ where i≧3. In each of the four algorithms, lost INTER-frames are error concealed by performing a copy-previous operation.

Referring now specifically to FIG. 4A, graphs 402 and 404 are provided that illustrate performance data for the EC_F0_{—}128, EC_F01_DC, and EC_MC_RF algorithms for the Foreman and Akiyo test sequences. The data illustrated in graphs 402 and 404 were obtained by simulating a case of INTRA-frame loss, where all subsequent frames are assumed to be received. As illustrated by graphs 402 and 404, video quality can be improved by just error concealing the first two frames of the video sequence by, for example, merely filling each frame with the DC coefficient of received INTRA-MBs. However, as further illustrated by graphs 402 and 404, significantly improved performance can be obtained using the EC_MV_DC_SI algorithm.

Turning to FIG. 4B, graphs 406 and 408 are provided that illustrate performance data for the EC_F0_{—}128, EC_F01_DC, and EC_MC_DC_SI algorithms for the Foreman and News test sequences under similar conditions to those illustrated by FIG. 4A. The parameter N=75 is utilized for the EC_MC_DC_SI algorithm in FIG. 4B. As illustrated by graphs 406 and 408, while video quality is improved from simple error concealment for the first two frames of the video sequence, the performance of the EC_MC_DC_SI can be significantly better than that achievable by simple error concealment.

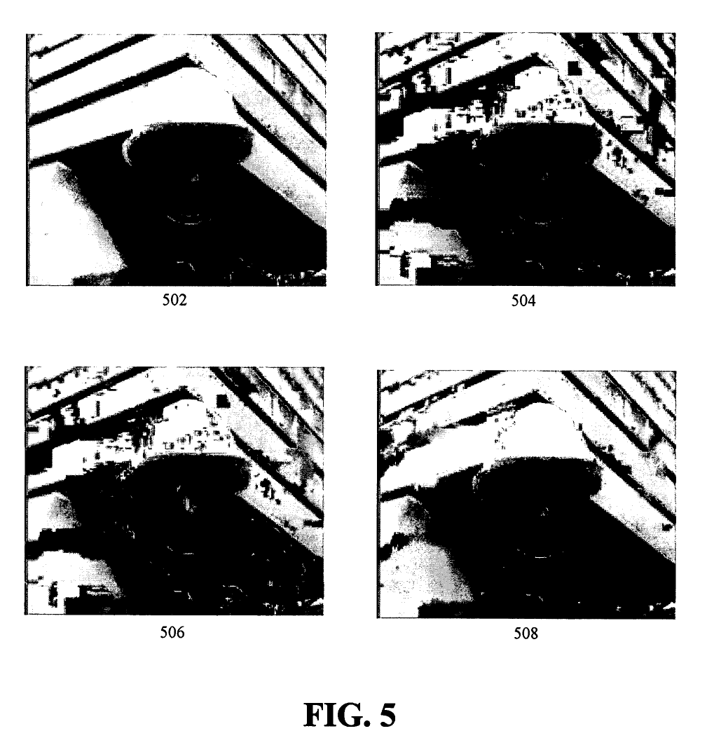

Referring to FIG. 5, images 502-508 are provided that illustrate image quality data for an exemplary error concealment system in accordance with various aspects described herein. In particular, image 502 illustrates the 30th INTER-frame of the Foreman test sequence as encoded and images 504-508 illustrate the 30th INTER-frame of the Foreman test sequence following a missing INTRA-frame in accordance with various error concealment algorithms. Image 504 was processed using the EC_F0_{—}128 algorithm, image 506 was processed using the EC_F01_DC algorithm, and image 508 was processed using the EC_MV_DC_SI algorithm. As can be observed from images 502-508, the EC_MV_DC_SI algorithm illustrated by image 508 can suppress propagated error more efficiently than the algorithms illustrated in images 504 and 506.

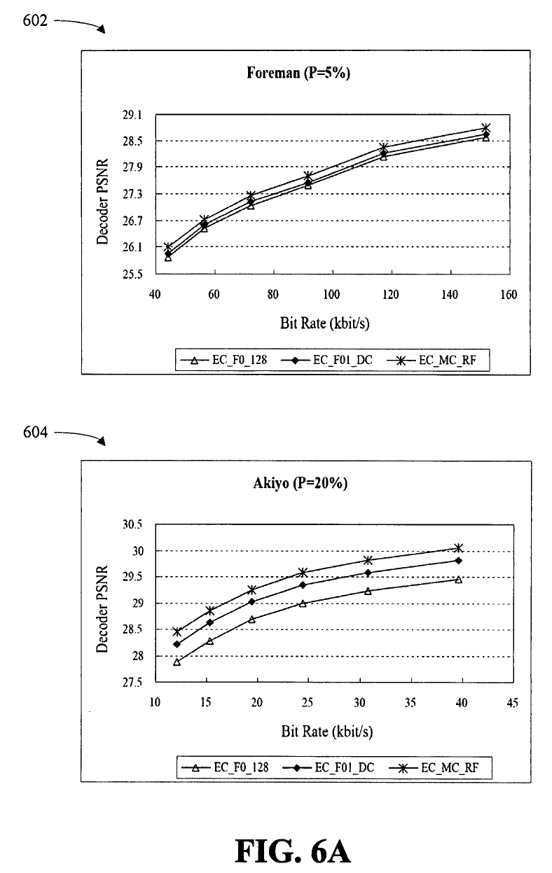

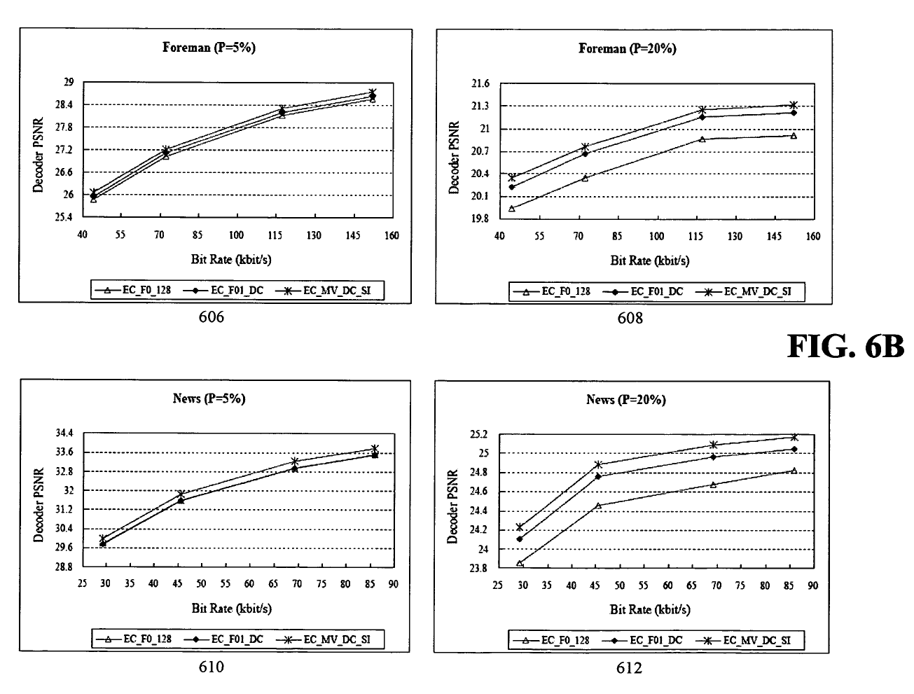

Turning now to FIG. 6A, graphs 602 and 604 are provided that illustrate performance data for an exemplary error concealment system in accordance with various aspects. This performance data is further illustrated by Table 1 as follows.

TABLE 1
Average decoder PSNR for different loss rates P.

| Decoder PSNR | | | | Delta-PSNR | | | |
|---|---|---|---|---|---|---|---|
| P | | | | | | | |
| 3% | 5% | 10% | 20% | 3% | 5% | 10% | 20% |

Foreman (QP = 30)

| | | | | | | | | |
|---|---|---|---|---|---|---|---|---|
| EC_F0_128 | 29.41 | 26.52 | 23.82 | 20.24 | 0.00 | 0.00 | 0.00 | 0.00 |
| EC_F01_DC | 29.47 | 26.59 | 23.94 | 20.51 | 0.06 | 0.07 | 0.12 | 0.27 |
| EC_MV_DC_SI | 29.59 | 26.72 | 24.03 | 20.59 | 0.18 | 0.20 | 0.21 | 0.35 |

Akiyo (QP = 30)

| | | | | | | | | |
|---|---|---|---|---|---|---|---|---|
| EC_F0_128 | 34.78 | 33.92 | 31.90 | 28.27 | 0.00 | 0.00 | 0.00 | 0.00 |
| EC_F01_DC | 34.82 | 34.00 | 32.02 | 28.63 | 0.04 | 0.08 | 0.12 | 0.36 |
| EC_MV_DC_SI | 34.94 | 34.23 | 32.18 | 28.84 | 0.16 | 0.31 | 0.28 | 0.57 |

Table 1 provides average decoder PSNRs for video transmission under different packet loss rates P. Further, Table 1 also presents the difference between the EC_F01_DC and EC_MC_RF algorithms from the EC_F0_{—}128 algorithm for the same loss rate, as shown in the column entitled Delta-PSNR. From Table 1, it can be observed that both the EC_F01_DC and EC_MC_RF algorithms can obtain a higher PSNR than the EC_F0_{—}128 algorithm and that this difference increases with the loss rate. Referring back to FIG. 6A, graphs 602 and 604 illustrate average decoder PSNRs for the EC_F01_DC, EC_MC_RF, and EC_F0_{—}128 algorithms as a function of bit rate for a given packet loss rate. From graph 602, it can be observed that a gain of approximately 0.2 dB can be achieved for the Foreman test sequence at a packet loss rate of P=5% by using EC_MC_RF compared to using EC_F0_{—}128. Similarly, it can be observed from graph 604 that a gain of approximately 0.6 dB can be achieved for the Akiyo test sequence at a packet loss rate of P=20% by using EC_MC_RF compared to using EC_F0_{—}128.

Referring to FIG. 6B, additional graphs 606-612 are provided that illustrate performance data for an exemplary error concealment system in accordance with various aspects. This performance data is further illustrated by Table 2 as follows, where the parameter N=30 is used for EC_MV_DC_SI.

TABLE 2
Average decoder PSNR for different loss rates P.

| Decoder PSNR | | | | Delta-PSNR | | | |
|---|---|---|---|---|---|---|---|
| P | | | | | | | |
| 3% | 5% | 10% | 20% | 3% | 5% | 10% | 20% |

Foreman (QP = 30)

| | | | | | | | | |
|---|---|---|---|---|---|---|---|---|
| EC_F0_128 | 29.41 | 26.52 | 23.82 | 20.24 | 0.00 | 0.00 | 0.00 | 0.00 |
| EC_F01_DC | 29.47 | 26.59 | 23.94 | 20.51 | 0.06 | 0.07 | 0.12 | 0.27 |
| EC_MV_DC_SI | 29.54 | 26.70 | 24.02 | 20.60 | 0.13 | 0.18 | 0.20 | 0.36 |

News (QP = 30)

| | | | | | | | | |
|---|---|---|---|---|---|---|---|---|
| EC_F0_128 | 32.37 | 30.61 | 28.28 | 24.08 | 0.00 | 0.00 | 0.00 | 0.00 |
| EC_F01_DC | 32.40 | 30.64 | 28.36 | 24.38 | 0.03 | 0.03 | 0.08 | 0.30 |
| EC_MV_DC_SI | 32.58 | 30.86 | 28.52 | 24.50 | 0.21 | 0.25 | 0.24 | 0.42 |

Table 2 provides average decoder PSNRs for video transmission under different packet loss rates P. Further, Table 1 also presents the difference between the EC_F01_DC and EC_MC_DC_SI algorithms from the EC_F0_{—}128 algorithm for the same loss rate, as shown in the column entitled Delta-PSNR. From Table 2, it can be observed that both the EC_F01_DC and EC_MC_RF algorithms can obtain a higher PSNR than the EC_F0_{—}128 algorithm and that this difference increases with the loss rate. Referring back to FIG. 6B, graphs 606-612 illustrate average decoder PSNRs for the EC_F01_DC, EC_MC_DC_SI, and EC_F0_{—}128 algorithms as a function of bit rate for a given packet loss rate. From graphs 606 and 610, it can be observed that respective gains of approximately 0.19 dB and 0.26 dB can be achieved for the Foreman and News test sequence at a packet loss rate of P=5% by using EC_MC_DC_SI compared to using EC_F0_{—}128. Similarly, it can be observed from graphs 608 and 612 that a gain of approximately 0.4 dB can be achieved for both the Foreman test sequence and the News test sequence at a packet loss rate of P=20% by using EC_MC_DC_SI compared to using EC_F0_{—}128. Further, graphs 606-612 illustrate that, for a small loss rate such as P=3% or 5%, the performance of the EC_F01_DC algorithm is closer to EC_F0_{—}128 than to EC_MV DC_SI. In addition, it can be observed that as P increases, the performance of EC_F01_DC becomes closer to the performance of EC_MV_DC_SI.

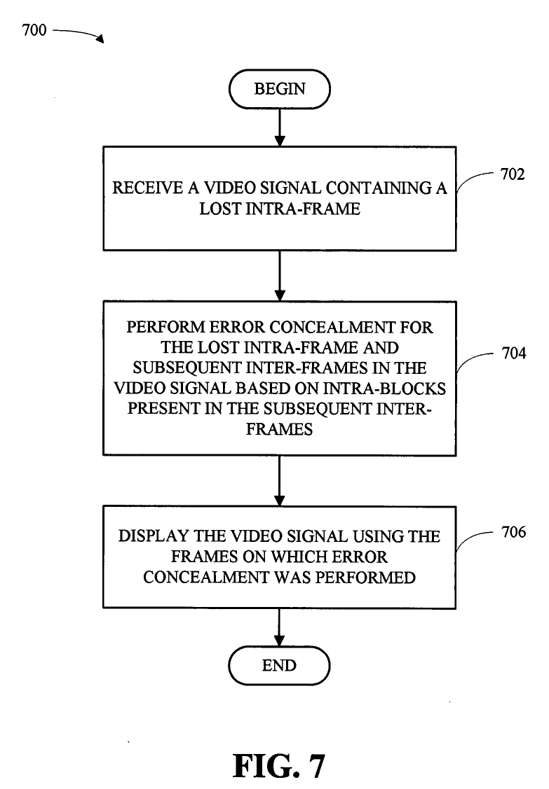

Referring now to FIGS. 7-9, methodologies that may be implemented in accordance with various aspects described herein are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies in accordance with the claimed subject matter.

Furthermore, the claimed subject matter may be described in the general context of computer-executable instructions, such as program modules, executed by one or more components. Generally, program modules include routines, programs, objects, data structures, etc., that perform particular tasks or implement particular abstract data types. Typically the functionality of the program modules may be combined or distributed as desired in various embodiments. Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

Referring to FIG. 7, a method 700 of processing a video signal (e.g., a video signal 120) in accordance with various aspects is illustrated. At 702, a video signal containing a lost INTRA-frame is received (e.g., by a receiving device 130 from a transmitting device 110). At 704, error concealment is performed (e.g., by an error concealment component 50) for the lost INTRA-frame and subsequent INTER-frames in the video signal based on INTRA-blocks present in the subsequent INTRA-frames (e.g., based on a RIR scheme implemented by an encoder 112 at the transmitting device 110). At 706, the video signal is displayed (e.g., by a display component 134) using the frames on which error concealment was performed.

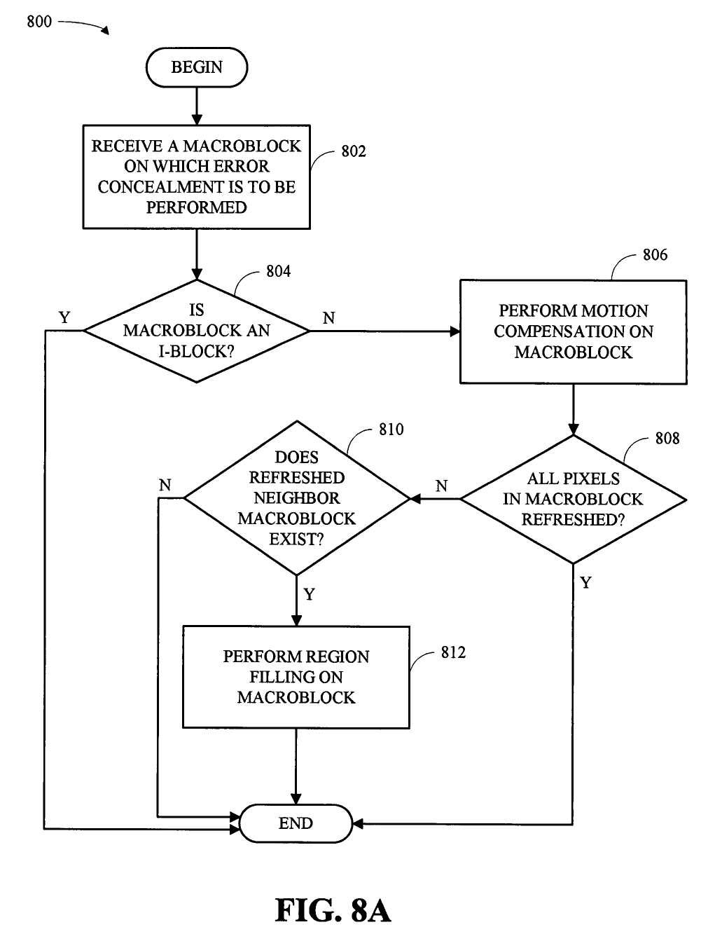

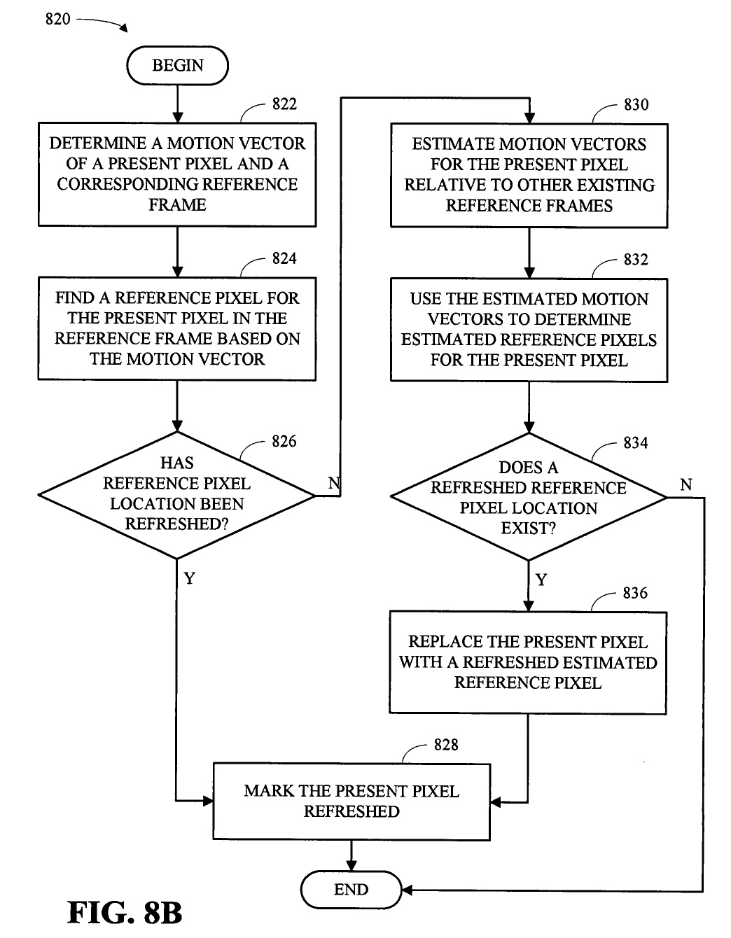

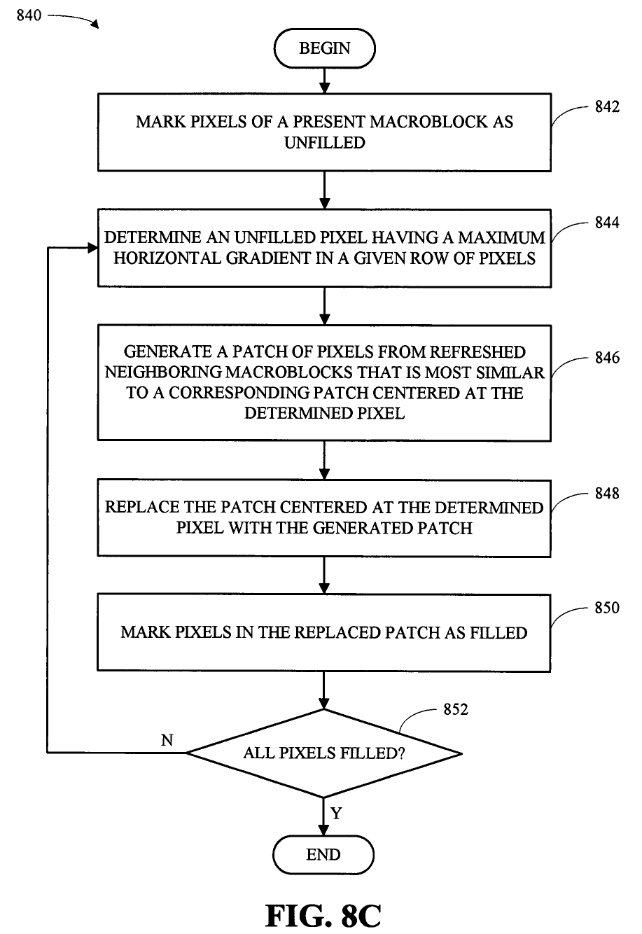

Turning to FIG. 8A, a method 800 of concealing an error in a video signal is illustrated. At 802, a macroblock on which error concealment is to be performed is received (e.g., by an error concealment component 50 in system 200). At 804, it is determined whether the macroblock received at 802 is an INTRA-coded block (or “I-block”). If the macroblock is an I-block, method 800 concludes. Otherwise, method 800 proceeds to 806, wherein motion compensation is performed on the macroblock (e.g., by a motion compensation component 820). At 808, it is then determined whether all pixels in the macroblock were refreshed by the motion compensation performed at 806. If all pixels have been refreshed, method 800 concludes. If all pixels have not been refreshed, method 800 can instead proceed to 810, where a further determination is made as to whether a fully refreshed macroblock borders the current macroblock. Method 800 can then again conclude upon a negative determination at 810 or proceed to 812 upon a positive determination prior to concluding, wherein region filling is performed on the macroblock (e.g., by a region filling component 230).

FIG. 8B illustrates a method 820 of concealing an error in a pixel using motion compensation. In one specific, non-limiting example, method 820 can be performed by an entity and/or a component of an entity that performs method 800. For example, method 800 can be performed by an error concealment component 50 in system 200, and method 820 can be performed by a motion compensation component 220 in the error concealment component 50. By way of an additional non-limiting example, method 820 can be used to carry out the motion compensation described at 806 as illustrated by FIG. 8A for respective pixels on which motion compensation is to be performed at 806.

Method 820 begins at 822, where a motion vector of a present pixel and a corresponding reference frame are determined. At 824, a reference pixel is found for the present pixel in the determined reference frame based on the motion vector determined at 822. At 826, it is determined whether the location of the reference pixel has been refreshed. If the reference pixel location has been refreshed, method 820 can conclude at 828 by marking the present pixel as refreshed. Otherwise, method 820 can proceed to 830, where motion vectors are estimated for the present pixel relative to other existing reference frames. At 832, the motion vectors estimated at 830 are used to determine estimated reference pixels for the present pixel. At 834, it is determined whether a refreshed reference pixel location exists among the reference pixel locations estimated at 832. If no refreshed pixel location exists, method 820 concludes. If a refreshed pixel location does exist, method 820 instead proceeds to 836, where the present pixel is replaced with a refreshed estimated reference pixel, and concludes at 828, where the present pixel is marked as refreshed.

FIG. 8C illustrates a method 840 of concealing an error in a macroblock using region filling. By way of non-limiting example, method 840 can be performed by an entity and/or a component of an entity that performs method 800 (e.g., a region filling component 230 at an error concealment component 50). As a further non-limiting example, method 840 can be used to carry out the region filling described at 812 as illustrated by FIG. 8A. Method 840 begins at 842, wherein pixels of a present macroblock are marked as unfilled. At 844, an unfilled pixel having a maximum horizontal gradient in a given row of pixels is determined. At 846, a patch of pixels is generated from refreshed neighboring macroblocks that is most similar to a corresponding patch centered at the pixel determined at 844. At 848, the patch centered at the pixel determined at 844 is replaced with the patch generated at 846. At 850, the pixels in the replaced patch are marked as filled. At 852, it is determined whether all pixels in the present macroblock have been filled. If all pixels have been filled, method 840 concludes. Otherwise, method 840 returns to 844 to determine a new pixel.

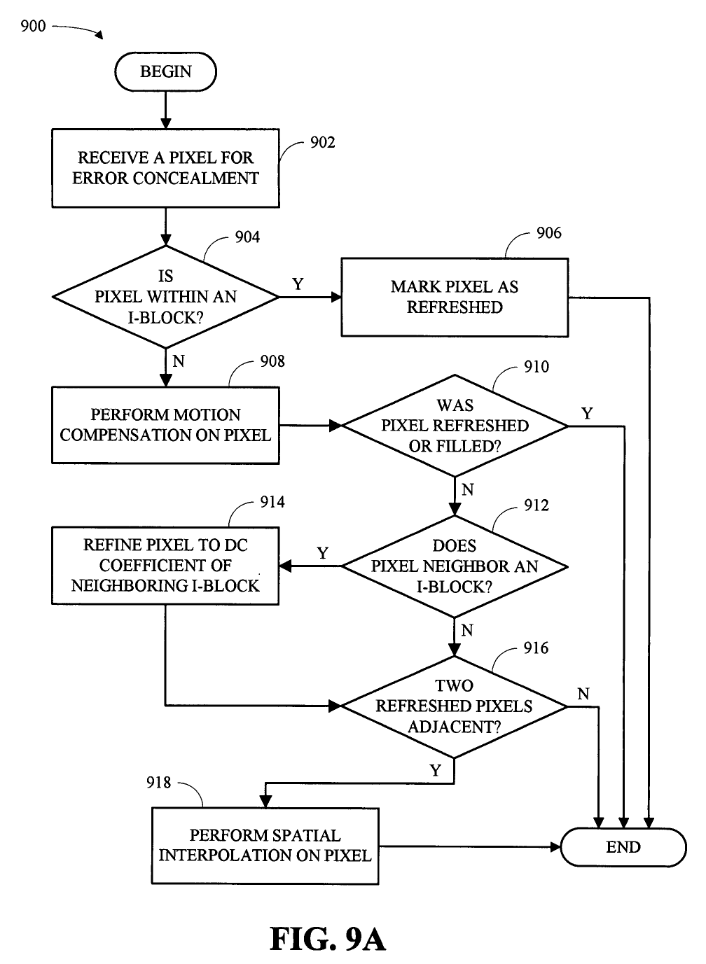

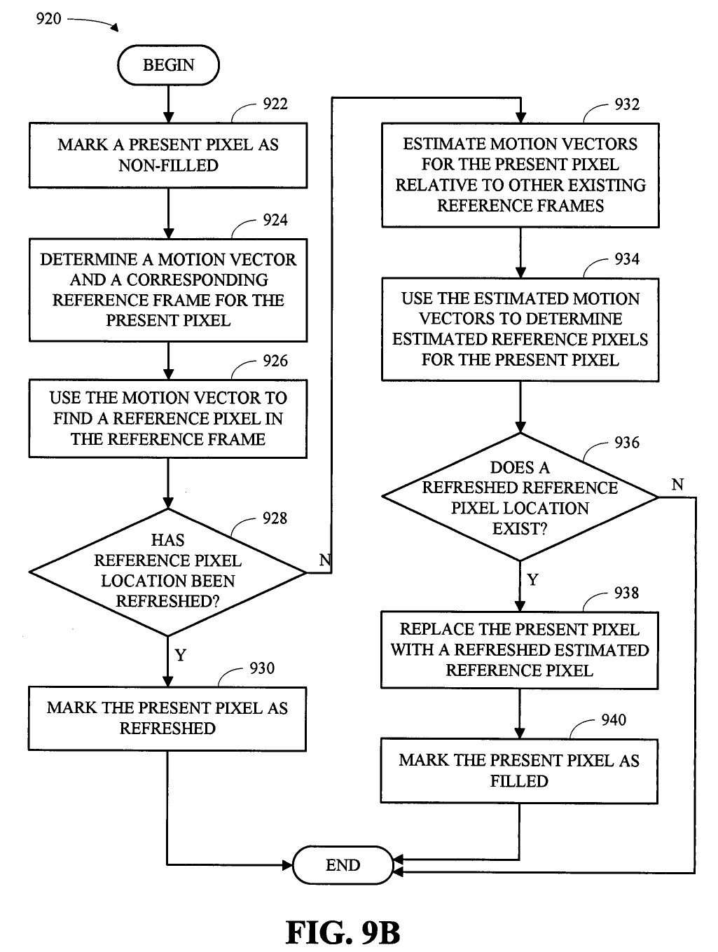

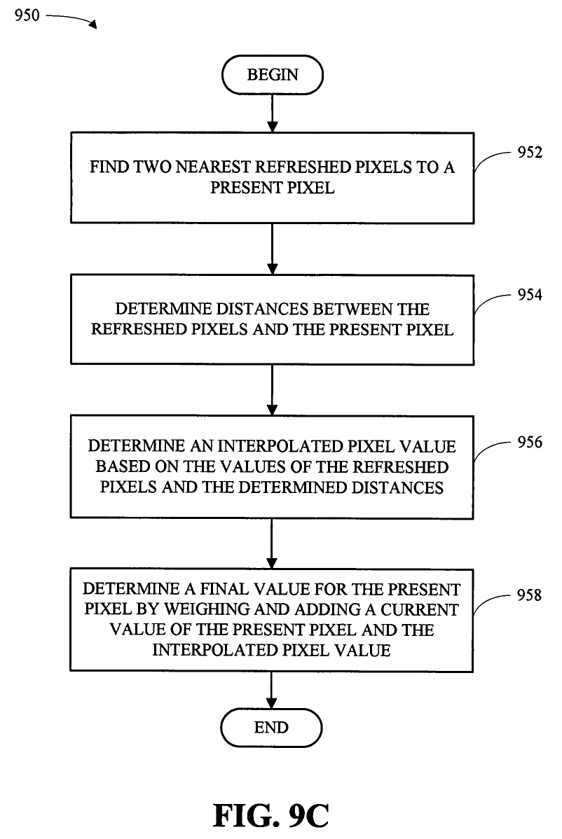

Turning to FIG. 9A, a method 900 of concealing an error in a video signal is illustrated. At 902, a pixel is received for error concealment (e.g., by an error concealment component in system 300). At 904, it is determined whether the pixel is located within an I-block. If the pixel is located within an I-block, method 900 concludes at 906, where the pixel is marked as refreshed. If the pixel is not located within an I-block, method 900 continues to 908, wherein motion compensation is performed on the pixel (e.g., by a motion compensation component 320). At 910, it is then determined whether the pixel was refreshed or filled by the motion compensation performed at 908. Method 900 can then conclude upon a positive determination at 910 or proceed to 912 upon a negative determination.

At 912, it is determined whether the pixel neighbors an I-block. If the pixel does not neighbor an I-block, method 900 can proceed to 916. Otherwise, method 900 can continue to 914 before proceeding to 916, wherein the pixel is refined to the DC coefficient of the neighboring I-block determined at 912 (e.g., by a DC coefficient refinement component 930). Next, at 916, it is determined whether there are two refreshed pixels adjacent to the current pixel. If a negative determination is reached at 916, method 900 concludes. On the other hand, if a positive determination is reached at 916, method 900 proceeds to 918 before concluding, where spatial interpolation is performed on the pixel (e.g., by a spatial interpolation component 940).

FIG. 9B illustrates a method 920 of concealing an error in a pixel using motion compensation. As a specific, non-limiting example, method 920 can be performed by an entity and/or a component of an entity that performs method 900. For example, method 900 can be performed by an error concealment component 50 in system 300, and method 920 can be performed by a motion compensation component 320 in the error concealment component 50. By way of an additional non-limiting example, method 920 can be used to carry out the motion compensation described at 908 as illustrated by FIG. 9A.

Method 920 begins at 922, where a present pixel is marked as non-filled. At 924, a motion vector and a corresponding reference frame for the present pixel are determined. At 926, a reference pixel is found for the present pixel in the determined reference frame based on the motion vector determined at 924. At 928, it is determined whether the location of the reference pixel found at 926 has been refreshed. If the reference pixel location has been refreshed, method 920 can conclude at 930 by marking the present pixel as refreshed. Otherwise, method 820 can proceed to 932, where motion vectors are estimated for the present pixel relative to other existing reference frames. At 934, the motion vectors estimated at 932 are used to determine estimated reference pixels for the present pixel. At 936, it is determined whether a refreshed reference pixel location exists among the reference pixel locations estimated at 934. If no refreshed pixel location exists, method 920 concludes. If a refreshed pixel location does exist, method 920 instead proceeds to 838, where the present pixel is replaced with a refreshed estimated reference pixel, and concludes at 940, where the present pixel is marked as filled.

FIG. 9C illustrates a method 950 of concealing an error in a pixel using spatial interpolation. By way of non-limiting example, method 950 can be performed by an entity and/or a component of an entity that performs method 900 (e.g., a spatial interpolation component 230 at an error concealment component 50). As a further non-limiting example, method 950 can be used to carry out the spatial interpolation described at 918 as illustrated by FIG. 9A. Method 950 begins at 952, wherein two nearest refreshed pixels to a present pixel are located. At 954, distances between the refreshed pixels found at 952 and the present pixel are determined. At 956, an interpolated pixel value is determined based on the values of the refreshed pixels found at 952 and the distances determined at 954. At 958, a final value for the present pixel is determined by weighing and adding the current value of the present pixel and the interpolated pixel value determined at 956.

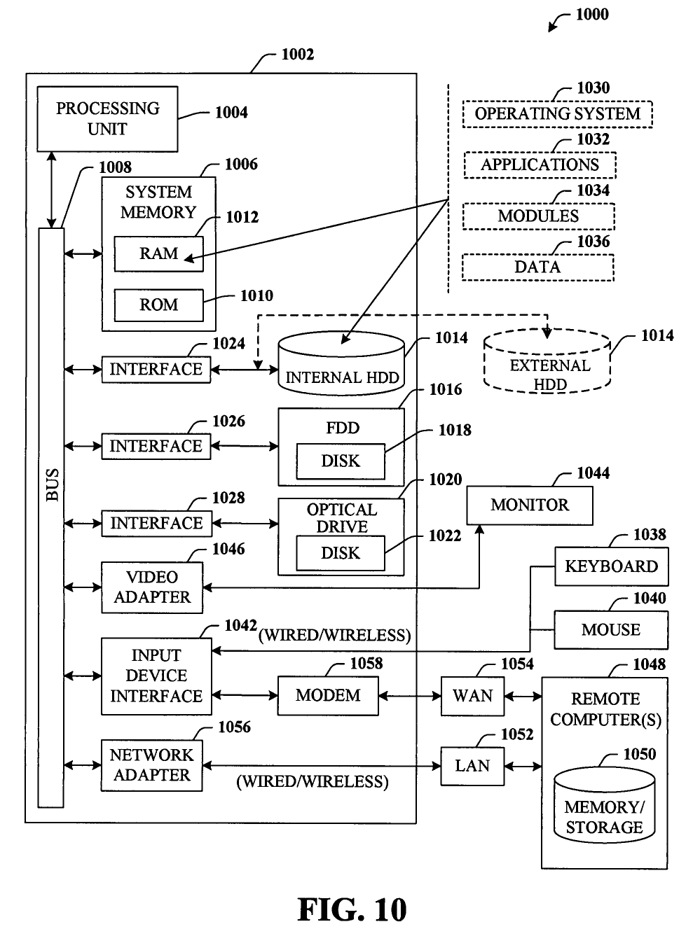

In order to provide additional context for various aspects described herein, FIG. 10 and the following discussion are intended to provide a brief, general description of a suitable computing environment 1000 in which various aspects described herein can be implemented. Additionally, while the claimed subject matter has been described above in the general context of computer-executable instructions that can run on one or more computers, those skilled in the art will recognize that the claimed subject matter also can be implemented in combination with other program modules and/or as a combination of hardware and software. Generally, program modules include routines, programs, components, data structures, etc., that perform particular tasks or implement particular abstract data types. Moreover, those skilled in the art will appreciate that the systems and methods above can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices. The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the example computing environment 1000 includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA) that can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE-1394 interface technologies. Other external drive connection technologies are within contemplation of the claimed subject matter.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing various methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, a serial port, an IEEE-1394 port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as remote computer(s) 1048. A remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, telephone, etc. This includes at least Wi-Fi and Bluetooth™ wireless technologies. Thus, the communication can be a predefined structure as with a conventional network or simply an ad hoc communication between at least two devices.

Wi-Fi, or Wireless Fidelity, is a wireless technology similar to that used in a cell phone that enables a device to send and receive data anywhere within the range of a base station. Wi-Fi networks use IEEE-802.11(a, b, g, etc.) radio technologies to provide secure, reliable, and fast wireless connectivity. A Wi-Fi network can be used to connect computers to each other, to the Internet, and to wired networks (which use IEEE-802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band). Thus, networks using Wi-Fi wireless technology can provide real-world performance similar to a 10 BaseT wired Ethernet network.

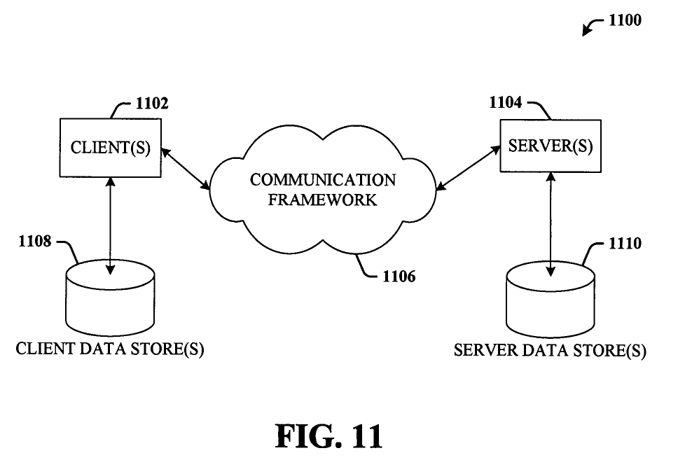

Referring now to FIG. 11, a block diagram of an example networked computing environment in which various aspects described herein can function is illustrated. The system 1100 includes one or more client(s) 1102. The client(s) 1102 can be hardware and/or software (e.g., threads, processes, computing devices). The system 1100 also includes one or more server(s) 1104. The server(s) 1104 can also be hardware and/or software (e.g., threads, processes, computing devices). One possible communication between a client 1102 and a server 1104 can be in the form of a data packet adapted to be transmitted between two or more computer processes. The data packet can include a video signal and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102. Similarly, the server(s) 1104 are operatively connected to one or more server data store(s) 1110 that can be employed to store information local to the servers 1104.

The claimed subject matter has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

What is claimed is:

1. A system for error-concealing a transmission error that causes one or more INTRA-coded frame losses in a video signal, comprising:
a frame loss detection component that detects a lost INTRA-coded frame in a video signal resulting from a transmission error; and
an error concealment component that conceals the transmission error in the lost INTRA-coded frame and one or more subsequent INTER-coded frames based at least in part on INTRA-coded macroblocks present in the one or more INTER-coded frames.

2. The system of claim 2, wherein the initial frame processing component initializes respective marks mapped to pixels in INTRA-coded macroblocks present in the one or more INTER-coded frames to indicate that the respective pixels are refreshed.

3. The system of claim 2, wherein the error concealment component further comprises a motion compensation component that determines whether respective motion trajectories for non-refreshed pixels in the one or more INTER-coded frames contain a refreshed pixel and refines respective non-refreshed pixels having motion trajectories that contain a refreshed pixel using a motion compensation algorithm.

4. The system of claim 3, wherein the motion compensation component replaces the respective non-refreshed pixels having motion trajectories that contain a refreshed pixel with the refreshed pixels in the respective motion trajectories and marks the replaced pixels as refreshed.

5. The system of claim 3, wherein the error concealment component further comprises a region filling component that receives a macroblock comprising pixels processed by the motion compensation component and fills the macroblock based on pixel values obtained from one or more neighboring macroblocks if the macroblock contains at least one non-refreshed pixel and at least one of the neighboring macroblocks contains only refreshed pixels.

6. The system of claim 5, wherein the region filling component fills the macroblock by replacing respective patches of pixels in the macroblock with patches of pixels obtained from a neighboring macroblock that contains only refreshed pixels.

7. The system of claim 5, wherein the region filling component fills the macroblock by replacing respective patches of pixels in the macroblock with respective patches of pixels generated as a weighted average of patches of pixels obtained from two or more neighboring macroblocks that contain only refreshed pixels.

8. The system of claim 3, wherein the error concealment component further comprises a DC coefficient refinement component that modifies a pixel processed by the motion compensation component upon a determination that the pixel is not refreshed and is within a predetermined distance of an INTRA-coded macroblock at least in part by changing a value of the pixel to a weighted average of an original value of the pixel and a DC coefficient of the INTRA-coded macroblock.

9. The system of claim 3, wherein the error concealment component further comprises a spatial interpolation component that receives a non-refreshed pixel and refines the non-refreshed pixel using a spatial interpolation algorithm if the non-refreshed pixel is within a predetermined distance of two or more refreshed pixels.

10. The system of claim 9, wherein the spatial interpolation component obtains an interpolated pixel value at least in part on respective values of two or more refreshed pixels to the non-refreshed pixel and respective distances between the refreshed pixels and the non-refreshed pixel and refines a value of the non-refreshed pixel using the interpolated pixel value.

11. A method for error-concealing a video signal, comprising:
receiving a video signal containing a lost INTRA-frame; and
performing error concealment for the lost INTRA-frame and one or more INTER-frames following the lost INTRA-frame based at least in part on INTRA-blocks present in the one or more INTER-frames.

12. The method of claim 11, wherein the performing error concealment comprises:
determining whether respective blocks in the one or more INTER-frames are INTER-blocks or INTRA-blocks;
indicating that error concealment is complete for pixels in respective INTRA-blocks;
performing motion compensation for respective INTER-blocks in the one or more INTER-frames; and
performing region filling to refine selected INTER-blocks in the one or more INTER-frames.

13. The method of claim 12, wherein the performing motion compensation comprises:
determining whether respective motion trajectories for pixels in the respective INTER-blocks contain a pixel for which error concealment is complete;
replacing pixels having motion trajectories that contain a pixel for which error concealment is complete with the respective pixels for which error concealment is complete; and
indicating that error concealment is complete for the replaced pixels.

14. The method of claim 13, wherein the performing region filling comprises:
selecting respective INTER-blocks for region filling at least in part by determining whether error concealment is complete for respective pixels in the respective INTER-blocks and blocks that neighbor the respective INTER-blocks; and
replacing pixels in the respective INTER-blocks with pixels obtained from one or more blocks that neighbor the respective INTER-blocks for which error concealment has completed or a weighted average of pixels obtained from two or more blocks that neighbor the respective INTER-blocks for which error concealment has completed.

15. The method of claim 11, wherein the performing error concealment comprises:
determining whether respective pixels in the one or more INTER-frames are located within an INTRA-block or an INTER-block;
indicating that error concealment is complete for respective pixels located within INTRA-blocks;
performing motion compensation for pixels located within the respective INTER-blocks;
performing DC coefficient refinement for a first set of selected pixels located within the respective INTER-blocks; and
performing spatial interpolation to refine a second set of selected pixels located within the respective INTER-blocks.

16. The method of claim 15, wherein the performing motion compensation comprises:
determining whether respective motion trajectories for pixels located within the respective INTER-blocks contain a pixel for which error concealment is complete;
replacing pixels having motion trajectories that contain a pixel for which error concealment is complete with the respective pixels for which error concealment is complete; and
indicating that error concealment is complete for the replaced pixels.

17. The method of claim 15, wherein the performing DC coefficient refinement comprises:
creating the first set of selected pixels at least in part by identifying pixels for which error concealment is not complete that are within a predetermined distance of respective INTRA-blocks; and
replacing respective pixels in the first set of selected pixels with respective weighted averages of original values of the respective pixels and DC coefficients of the respective INTRA-blocks.

18. The method of claim 15, wherein the performing spatial interpolation comprises:
creating the second set of selected pixels at least in part by identifying pixels for which error concealment is not complete that are within a predetermined distance of two or more pixels for which error concealment is complete;
generating respective interpolated pixel values based on the two or more pixels for which error concealment is complete that are within a predetermined distance of respective pixels in the second set of selected pixels; and
replacing respective pixels in the second set of selected pixels with respective weighted averages of original values of the respective pixels and the respective interpolated pixel values.

19. A computer-readable medium having stored thereon instructions operable to perform the method of claim 12.

20. A system for processing a video signal, comprising:
means for receiving a video signal on a communication channel, the video signal comprising one or more packets;
means for determining that a packet corresponding to an INTRA-coded frame in the video signal has been lost; and
means for generating video information to replace the lost packet in the video signal and refining subsequent video frames based at least in part on INTRA-coded information provided in one or more correctly received packets.
